(19) United States
(12) Patent Application Publication
(10) Pub. No.: US 2016/0376495 A1
(43) Pub. Date: Dec. 29, 2016

(54) LIQUID SLURRIES OF MICRON- AND NANO-SIZED SOLIDS FOR USE IN SUBTERRANEAN OPERATIONS

(71) Applicant: HALLIBURTON ENERGY SERVICES, INC., Housston, TX (US)

(72) Inventors: Philip D. Nguyen, Houston, TX (US); James William Ogle, Spring, TX (US); Bradley J. Sparks, Richmond, TX (US); Brian D. Mock, Kingwood, TX (US)

(21) Appl. No.: 15/038,933

(22) PCT Filed: Dec. 30, 2013
(86) PCT No.: PCT/US2013/078326

§ 371 Date: May 24, 2016

(51) Int. Cl. C09K 8/70; C09K 8/90; C09K 8/68; E21B 43/26; E21B 43/267

(52) U.S. Cl. CPC C09K 8/70; E21B 43/26; E21B 43/267; C09K 8/68; C09K 8/905; C09K 2208/10

(57) ABSTRACT

Compositions and methods for storing, transporting, and/or delivering micron- and/or nano-sized solid materials in subterranean operations are provided. In one embodiment, the methods comprise: providing a fluid comprising an aqueous fluid and one or more gelling agents; mixing one or more small-sized solid materials into the fluid to form a slurry; storing the slurry for a period of storage time; mixing at least a portion of the slurry with a base fluid after the period of storage time to form a treatment fluid; and introducing the treatment fluid into a well bore penetrating at least a portion of a subterranean formation.

### BACKGROUND

The present disclosure relates to compositions and methods for use in subterranean operations, and more specifically, compositions and methods for storing, transporting, and/or delivering micron- and/or nano-sized solid materials (e.g., particulates, fibers, etc.) in subterranean operations.

In the production of hydrocarbons from a subterranean formation, the subterranean formation should be sufficiently conductive to permit the flow of desirable fluids to a well bore penetrating the formation. One type of treatment used in the art to increase the conductivity of a subterranean formation is hydraulic fracturing. Hydraulic fracturing operations generally involve pumping a treatment fluid (e.g., a fracturing fluid or a “pad fluid”) into a well bore that penetrates a subterranean formation at or above a sufficient hydraulic pressure to create or enhance one or more pathways, or “fractures,” in the subterranean formation. These fractures generally increase the permeability of that portion of the formation. The fluid may comprise particulates, often referred to as “proppant particulates,” that are deposited in the resultant fractures. The proppant particulates are thought to help prevent the fractures from fully closing upon the release of the hydraulic pressure, forming conductive channels through which fluids may flow to a well bore.

Treatment fluids are also utilized in sand control treatments, such as gravel packing. In “gravel-packing” treatments, a treatment fluid suspends particulates (commonly referred to as “gravel particulates”), and at least a portion of those particulates are then deposited in a desired area in a well bore, e.g., near unconsolidated or weakly consolidated formation zones, to form a “gravel pack,” which is a grouping of particulates that are packed sufficiently close together so as to prevent the passage of certain materials through the gravel pack. This “gravel pack” may, inter alia, enhance sand control in the subterranean formation and/or prevent the flow of particulates from an unconsolidated portion of the subterranean formation (e.g., a propped fracture) into a well bore. One common type of gravel-packing operation involves placing a sand control screen in the well bore and packing the annulus between the screen and the well bore with the gravel particulates of a specific size designed to prevent the passage of formation sand. The gravel particulates act, inter alia, to prevent the formation sand from occluding the screen or migrating with the produced hydrocarbons, and the screen acts, inter alia, to prevent the particulates from entering the well bore. The gravel particulates also may be coated with certain types of materials, including resins, tackifying agents, and the like. Once the gravel pack is substantially in place, the viscosity of the treatment fluid may be reduced to allow it to be recovered. In some situations, fracturing and gravel-packing treatments are combined into a single treatment (commonly referred to as “FracPac™” operations). In such “FracPac™” operations, the treatments are generally completed with a gravel pack screen assembly in place with the hydraulic fracturing treatment being pumped through the annular space between the casing and screen. In this situation, the hydraulic fracturing treatment ends in a screen-out condition, creating an annular gravel pack between the screen and casing. In other cases, the fracturing treatment may be performed prior to installing the screen and placing a gravel pack.

Certain proppant or gravel particulates may comprise various types of materials, including fine particulate material and dust (e.g., fine particulate silica). However, the handling and use of such materials by personnel conducting subterranean operations may present certain health and safety hazards, as exposure to and inhalation of such materials can cause silicosis and other health conditions.

### BRIEF DESCRIPTION OF THE FIGURES

These drawings illustrate certain aspects of some of the embodiments of the present disclosure, and should not be used to limit or define the disclosure.

FIG. 1 is a diagram illustrating an example of a fracturing system that may be used in accordance with certain embodiments of the present disclosure.

FIG. 2 is a diagram illustrating an example of a subterranean formation in which a fracturing operation may be performed in accordance with certain embodiments of the present disclosure.

While embodiments of this disclosure have been depicted and described and are defined by reference to example embodiments of the disclosure, such references do not imply a limitation on the disclosure, and no such limitation is to be inferred. The subject matter disclosed is capable of considerable modification, alteration, and equivalents in form and function, as will occur to those skilled in the pertinent art and having the benefit of this disclosure. The depicted and described embodiments of this disclosure are examples only, and not exhaustive of the scope of the disclosure.

### DETAILED DESCRIPTION

Illustrative embodiments of the present disclosure are described in detail herein. In the interest of clarity, not all features of an actual implementation may be described in this specification. It will of course be appreciated that in the development of any such actual embodiment, numerous implementation-specific decisions may be made to achieve the specific implementation goals, which may vary from one implementation to another. Moreover, it will be appreciated that such a development effort might be complex and time-consuming, but would nevertheless be a routine undertaking for those of ordinary skill in the art having the benefit of the present disclosure.

The present disclosure relates to compositions and methods for use in subterranean operations, and more specifically, for storing, transporting, and/or delivering micron- and/or nano-sized solid materials (e.g., particulates, fibers, etc.) in subterranean operations.

More specifically, the present disclosure provides compositions (e.g., slurries) comprising a plurality of small-sized solid materials, such as particulates and/or fibers, and methods of using those compositions to store, transport, and/or deliver the solids (e.g., as proppant particulates) to at least a portion of a subterranean formation. As used herein, the term “small-sized solid materials” refers to materials that consist of one or more of micron-sized solids, nano-sized solids, or any combination thereof. The compositions of the present disclosure generally comprise an aqueous fluid (e.g., a gel) viscosified with a gelling agent, and a plurality of micron-sized and/or nano-sized solids. Such micron-sized and/or nano-sized solids may be used, for example, in fracturing operations to prop open and maintain the permeability of fractures in tight formations, microfractures, and/or dendritic fractures in the tip region of a primary fracture or far-field areas of a subterranean formation. As used herein, the term “microfracture” refers to a discontinuity in a portion of a subterranean formation creating a flow channel, the flow channel generally having a width or flow opening size in the range of from about 1 μm to about 250 μm.

The methods and compositions of the present disclosure may, among other benefits, facilitate the storage, handling, transportation, and/or use of micron-sized and nano-sized particulates and fibers in subterranean operations. Such materials may, among other benefits, enable more effective stimulation (e.g., fracturing) of certain types of tight formations, such as shales, clays, coal beds, and/or gas sands. In certain embodiments, the disclosed methods and compositions may enable the storage of such micron-sized and nano-sized solids for extended periods of time. In certain embodiments, the disclosed methods and compositions may reduce the generation of fine dust during the application of micron-sized and nano-sized solids, which may mitigate environmental, safety, toxicity, and/or other risks associated with the use of these materials.

The aqueous fluid used in the methods and compositions of the present disclosure may comprise any aqueous fluid known in the art. Suitable aqueous fluids may comprise water from any source, provided that it does not contain compounds that adversely affect other components of the fluid. Such aqueous fluids may comprise fresh water, salt water (e.g., water containing one or more salts dissolved therein), brine (e.g., saturated salt water), seawater, or any combination thereof. In certain embodiments, the density of the aqueous fluid can be adjusted, among other purposes, to provide additional particulate transport and suspension in the compositions of the present disclosure. In certain embodiments, the pH of the aqueous fluid may be adjusted (e.g., by a buffer or other pH adjusting agent) to a specific level, which may depend on, among other factors, the types of gelling agents, acids, and other additives included in the fluid. One of ordinary skill in the art, with the benefit of this disclosure, will recognize when such density and/or pH adjustments are appropriate.

The micron- and/or nano-sized solid materials used in accordance with the present disclosure may comprise any solid materials known in the art of the applicable particle size, such as particulates and fibers. The micron-sized solids used in accordance with the present disclosure generally have particle sizes ranging from about 1 micron to about 250 microns. In certain embodiments, the micron-sized particulates may have particle sizes smaller than 100 mesh (149 μm), and in certain embodiments may have particle sizes equal to or smaller than 200 mesh (74 μm), 230 mesh (63 μm) or even 325 mesh (44 μm). The nano-sized solids used in accordance with the present disclosure generally have particle sizes ranging from about 10 nanometers to about 1000 nanometers. In certain embodiments, micron- or nano-sized fibers may be used in accordance with the present disclosure, the fibers having diameters less than about 250 microns and lengths less than about 3000 microns. In certain embodiments, the micron-sized fibers may have diameters of about 10 microns to about 250 microns and lengths of about 100 microns to about 3000 microns. In certain embodiments, micron- or nano-sized fibers may provide, among other properties, better stress distribution in a proppant or gravel pack as compared to other micron- or nano-sized solids.

The micron- and/or nano-sized solids may be intended for any applicable use in subterranean operations, for example, as proppant particulates, gravel particulates, suspending agents, or the like. The micron- and nano-sized solids may be naturally occurring or man-made, and may be comprised of any material known in the art that does not interfere with their intended use. Examples of suitable materials may include, but are not limited to, silica, silicates, glass, bauxite, sand, polymeric materials, ceramics, rubber, resins, composites, and the like. In certain embodiments, the micron- and/or nano-sized solids may be at least partially coated with another substance such as a resin, tackifying agent, or other coating. Suitable micron- and nano-sized particulates may have any physical shape, including but not limited to shapes such as platelets, shavings, fibers, flakes, ribbons, rods, strips, spheroids, discs, toroids, pellets, tablets, and the like. Suitable micron- and nano-sized fibers generally comprise elongated structures and may have any cross-sectional shape, including but not limited to, round, oval, trilobal, star, flat, rectangular, etc. One example of a micron-sized particulate material that may be suitable for use in accordance with the present disclosure is silica flour, for example, in the form of 325-mesh or 200-mesh silica powder. An example of a commercially-available product comprising these materials is the WAC-9™ fluid loss additive, available from Halliburton Energy Services, Inc. Another example of suitable micron-sized particulate materials that may be suitable for use in accordance with the present disclosure is microspheres such as N-1000 Zeeospheres™ available from Zeeospheres Ceramics LLC. One example of a nano-sized particulate material that may be suitable for use in accordance with the present disclosure are the Laponite® family of additives (nano-sized disc-shaped silicate crystals), available from Rockwood Specialties, Inc.

The micron- and/or nano-sized solids may be included in a composition or slurry of the present disclosure in any amount that may be suspended therein. In certain embodiments, the compositions or slurries of the present disclosure may comprise a combination of micron-sized solids and nano-sized solids. In certain embodiments, the micron- and/or nano-sized solids may be included in a concentration of about 1 ppg (pounds per gallon) to about 30 ppg. In certain embodiments, the micron- and/or nano-sized solids may be included in a concentration of about 10 ppg (pounds per gallon) to about 25 ppg. In certain embodiments, the sizes of the micron- and/or nano-sized solids and their respective amounts may be selected to provide a distribution of particle sizes that, among other benefits, facilitates the mixing and/or suspension of the solids in a gelled fluid and/or reduces settling of the solids over time. The amounts of nano-sized solids included in a composition or slurry of the present disclosure also may affect the amount of micron-sized solids that can be included, and vice-versa. For example, including higher concentrations of nano-sized solids in a composition or slurry of the present disclosure may require reducing the amount of micron-sized solids included in that composition or slurry in order to effectively suspend the solids. A person of skill in the art, with the benefit of this disclosure, will recognize how to adjust the amounts of micron- and/or nano-sized solids in a particular composition or slurry of the present disclosure to balance, among other factors, the storage and suspension capability of the slurry, as well as the ability to pump, pour, and mix the slurry with other components in its use.

The gelling agents used in the methods and compositions of the present disclosure may comprise any substance that is capable of increasing the viscosity of a fluid, for example, by forming a gel. In certain embodiments, the gelling agent may viscosify an aqueous fluid when it is hydrated and present at a sufficient concentration. The gelling agent may, among other benefits, enhance the suspension of the solids in a composition of the present disclosure (e.g., during storage and/or transport), and/or may aid in viscosifying the fracturing fluid, for example, to enhance proppant transport or act as a friction reducer for reducing friction pressure. Examples of gelling agents that may be suitable for use in accordance with the present disclosure include, but are not limited to guar, guar derivatives (e.g., hydroxyethyl guar, hydroxypropyl guar, carboxymethyl guar, carboxymethylhydroxyethyl guar, and carboxymethylhydroxypropyl guar (“CMHPG”)), cellulose, cellulose derivatives (e.g., hydroxyethyl cellulose, carboxyethylcellulose, carboxymethylcellulose, and carboxymethylhydroxyethylcellulose), biopolymers (e.g., xanthan, scleroglucan, diutan, etc.), starches, chitosans, clays, polyvinyl alcohols, acrylamides, acrylates, viscoelastic surfactants (e.g., methyl ester sulfonates, hydrolyzed keratin, sulfosuccinates, taurates, amine oxides, ethoxylated amides, alkoxylated fatty acids, alkoxylated alcohols, ethoxylated fatty amines, ethoxylated alkyl amines, betaines, modified betaines, alkylamidobetaines, etc.), combinations thereof, and derivatives thereof. The term “derivative” is defined herein to include any compound that is made from one of the listed compounds, for example, by replacing one atom in the listed compound with another atom or group of atoms, rearranging two or more atoms in the listed compound, ionizing the listed compounds, or creating a salt of the listed compound. The gelling agent may be included in any concentration sufficient to impart the desired viscosity and/or suspension properties to the aqueous fluid. In certain embodiments, the gelling agent may be included in an amount of from about 0.1% to about 5% by weight of the aqueous fluid. In other exemplary embodiments, the gelling agent may be present in the range of from about 0.1% to about 2% by weight of the aqueous fluid.

The compositions of the present disclosure optionally may comprise any number of additional additives, among other reasons, to enhance and/or impart additional properties of the composition. For example, the compositions of the present disclosure optionally may comprise one or more salts, among other reasons, to act as a clay stabilizer and/or enhance the density of the composition, which may facilitate its incorporation into a fracturing fluid. In certain embodiments, the compositions of the present disclosure optionally may comprise one or more dispersants, among other reasons, to prevent flocculation and/or agglomeration of the solids while suspended in slurry. Other examples of such additional additives include, but are not limited to, salts, surfactants, acids, fluid loss control additives, gas, nitrogen, carbon dioxide, foamers, corrosion inhibitors, scale inhibitors, catalysts, clay control agents, biocides, friction reducers, antifoam agents, bridging agents, flocculants, additional H₂S scavengers, CO₂ scavengers, oxygen scavengers, lubricants, viscosifiers, breakers, weighting agents, relative permeability modifiers, wetting agents, coating enhancement agents, filter cake removal agents, antifreeze agents (e.g., ethylene glycol), and the like. A person skilled in the art, with the benefit of this disclosure, will recognize the types of additives that may be included in the fluids of the present disclosure for a particular application. In certain embodiments, the compositions of the present disclosure may not comprise a significant amount of cementitious materials.

The compositions and slurries of the present disclosure may be prepared using any suitable method and/or equipment (e.g., blenders, stirrers, etc.) known in the art at any time prior to their use. The compositions and slurries may be prepared at a well site or at an offsite location. In certain embodiments, an aqueous fluid may be mixed with the gelling agent first, among other reasons, in order to allow the gelling agent to hydrate and form a gel. Once the gel is formed, the micron- and/or nano-sized solids may be mixed into the gelled fluid. In certain embodiments where a combination of micron-sized solids and nano-sized solids are used, the nano-sized solids may be mixed into the gelled fluid before the micron-sized solids, among other reasons, because it may be more difficult to mix nano-sized solids into a fluid already containing micron-sized solids. Once prepared, a composition or slurry of the present disclosure may be placed in a tank, bin, or other container for storage and/or transport to the site where it is to be used. In certain embodiments, a composition or slurry of the present disclosure may remain stable (e.g., with the solids contained therein remaining suspended and minimal settling) for a period of time which may extend for as few as several days (e.g., about 2 days) to as long as about several weeks (e.g., about 3 weeks) after its preparation.

The methods and compositions of the present disclosure may be used during or in conjunction with any subterranean operation. For example, the methods and/or compositions of the present disclosure may be used in the course of a fracturing treatment in which a fracturing fluid may be introduced into the formation at or above a pressure sufficient to create or enhance one or more fractures in at least a portion of the subterranean formation. Such fractures may be “enhanced” where a pre-existing fracture (e.g., naturally occurring or otherwise previously formed) is enlarged or lengthened by the fracturing treatment. In certain embodiments, the fracturing fluid may be prepared, at least in part, by incorporating a slurry of the present disclosure with one or more other fluids. In certain embodiments, this may be accomplished using a pumping system and/or equipment similar to that described below. Other suitable subterranean operations in which the methods and/or compositions of the present disclosure may be used include, but are not limited to, acidizing treatments (e.g., matrix acidizing and/or fracture acidizing), hydrajetting treatments, sand control treatments (e.g., gravel packing), “frac-pack” treatments, and other operations where micron-sized and/or nano-sized particulates and/or fibers as may be useful.

A fracturing fluid of the present disclosure may be prepared by mixing one or more base fluids with a composition or slurry of the present disclosure by any means known in the art. The base fluid may comprise one or more aqueous based fluids, non-aqueous based fluids, or a combination thereof. For example, the base fluid may comprise water, slickwater, a hydrocarbon fluid, a polymer gel, foam, an emulsion, air, wet gases, and/or any combination thereof. The base fluid also may incorporate one or more additional additives, among other reasons, to impart or alter one or more properties of the fracturing fluid. The base fluid may be mixed with a composition or slurry of the present disclosure at a well site where the fracturing operation is conducted, either by batch mixing or continuous (“on-the-fly”) mixing. The term “on-the-fly” is used herein to include methods of combining two or more components wherein a flowing stream of one element is continuously introduced into a flowing stream of another component so that the streams are combined and mixed while continuing to flow as a single stream as part of the on-going treatment. Such mixing can also be described as “real-time” mixing. The composition or slurry of the present disclosure may be added to the base fluid in an amount of from about 0.01 ppg to about 1 ppg of the base fluid. In certain embodiments, it may be desirable for the density of a slurry or other composition of the present disclosure to match the density of the base fluid into which it is incorporated. This may be accomplished, among other ways, by adding one or more salts or weighting agents to the slurry or composition to adjust its density prior to mixing it into the base fluid.

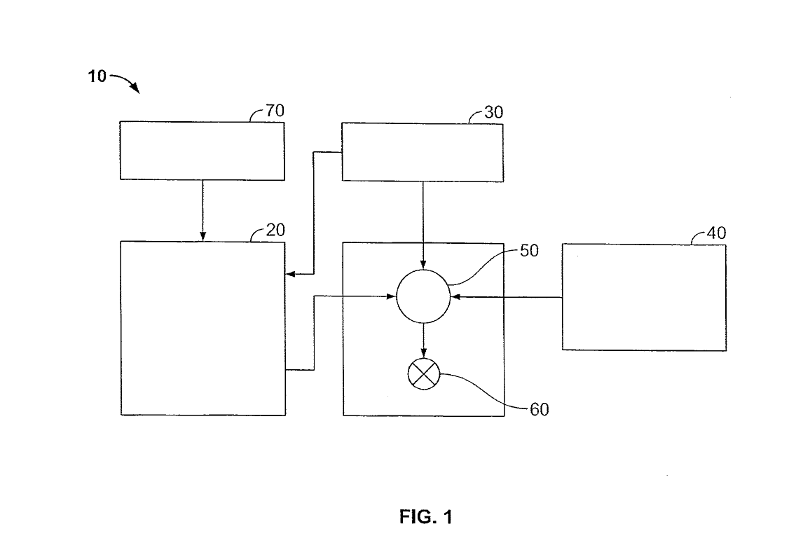

The exemplary methods and compositions disclosed herein may directly or indirectly affect one or more components or pieces of equipment associated with the preparation, delivery, recapture, recycling, reuse, and/or disposal of the disclosed compositions. For example, and with reference to FIG. 1, the disclosed methods and compositions may directly or indirectly affect one or more components or pieces of equipment associated with an exemplary fracturing system 10, according to one or more embodiments. In certain instances, the system 10 includes a fracturing fluid producing apparatus 20, a fluid source 30, a proppant source 40, and a pump and blender system 50 and resides at the surface at a well site where a well 60 is located. In certain instances, the fracturing fluid producing apparatus 20 combines a gel pre-cursor with fluid (e.g., liquid or substantially liquid) from fluid source 30, to produce a hydrated fracturing fluid that is used to fracture the formation. The hydrated fracturing fluid can be a fluid for ready use in a fracture stimulation treatment of the well 60 or a concentrate to which additional fluid is added prior to use in a fracture stimulation of the well 60. In other instances, the fracturing fluid producing apparatus 20 can be omitted and the fracturing fluid sourced directly from the fluid source 30. In certain instances, the fracturing fluid may comprise water, a hydrocarbon fluid, a polymer gel, foam, air, wet gases and/or other fluids.

The proppant source 40 can include a pre-made proppant for combination with the fracturing fluid and/or, in the methods of the present disclosure, a composition or slurry of the present disclosure comprising a plurality of micron-sized and/or nano-sized proppant particulates. The system may also include additive source 70 that provides one or more additives (e.g., gelling agents, weighting agents, and/or other optional additives) to alter the properties of the fracturing fluid. For example, the other additives 70 can be included to reduce pumping friction, to reduce or eliminate the fluid's reaction to the geological formation in which the well is formed, to operate as surfactants, and/or to serve other functions.

The pump and blender system 50 receives the fracturing fluid and combines it with other components, including proppant from the proppant source 40 and/or additional fluid from the additives 70. The resulting mixture may be pumped down the well 60 under a pressure sufficient to create or enhance one or more fractures in a subterranean zone, for example, to stimulate production of fluids from the zone. Notably, in certain instances, the fracturing fluid producing apparatus 20, fluid source 30, and/or proppant source 40 may be equipped with one or more metering devices (not shown) to control the flow of fluids, proppants, and/or other compositions to the pumping and blender system 50. Such metering devices may permit the pumping and blender system 50 can source from one, some or all of the different sources at a given time, and may facilitate the preparation of fracturing fluids in accordance with the present disclosure using continuous mixing or “on-the-fly” methods. Thus, for example, the pumping and blender system 50 can provide just fracturing fluid into the well at some times, just proppants or slurries of the present disclosure at other times, and combinations of those components at yet other times.

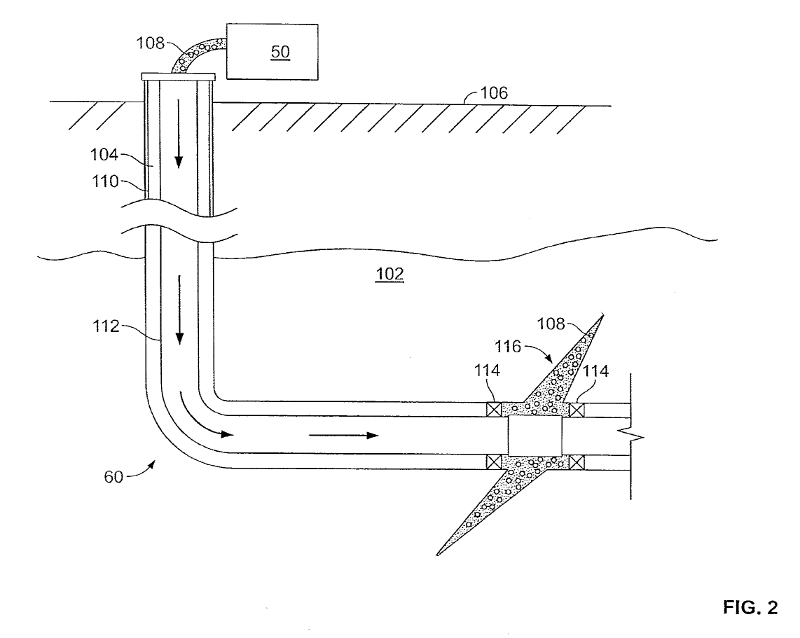

FIG. 2 shows the well 60 during a fracturing operation in a portion of a subterranean formation of interest 102 surrounding a well bore 104. The well bore 104 extends from the surface 106, and the fracturing fluid 108 is applied to a portion of the subterranean formation 102 surrounding the horizontal portion of the well bore. Although shown as vertical deviating to horizontal, the well bore 104 may include horizontal, vertical, slant, curved, and other types of well bore geometries and orientations, and the fracturing treatment may be applied to a subterranean zone surrounding any portion of the well bore. The well bore 104 can include a casing 110 that is cemented or otherwise secured to the well bore wall. The well bore 104 can be uncased or include uncased sections. Perforations can be formed in the casing 110 to allow fracturing fluids and/or other materials to flow into the subterranean formation 102. In cased wells, perforations can be formed using shape charges, a perforating gun, hydro jetting and/or other tools.

The well is shown with a work string 112 depending from the surface 106 into the well bore 104. The pump and blender system 50 is coupled a work string 112 to pump the fracturing fluid 108 into the well bore 104. The working string 112 may include coiled tubing, jointed pipe, and/or other structures that allow fluid to flow into the well bore 104. The working string 112 can include flow control devices, bypass valves, ports, and or other tools or well devices that control a flow of fluid from the interior of the working string 112 into the subterranean zone 102. For example, the working string 112 may include ports adjacent the well bore wall to communicate the fracturing fluid 108 directly into the subterranean formation 102, and/or the working string 112 may include ports that are spaced apart from the well bore wall to communicate the fracturing fluid 108 into an annulus in the well bore between the working string 112 and the well bore wall.

The working string 112 and/or the well bore 104 may include one or more sets of packers 114 that seal the annulus between the working string 112 and well bore 104 to define an interval of the well bore 104 into which the fracturing fluid 108 will be pumped. FIG. 2 shows two packers 114, one defining an uphole boundary of the interval and one defining the downhole end of the interval. When the fracturing fluid 108 is introduced into well bore 104 (e.g., in FIG. 2, the area of the well bore 104 between packers 114) at a sufficient hydraulic pressure, one or more fractures 116 may be created in the subterranean zone 102. The proppant particulates in the fracturing fluid 108 may enter the fractures 116 where they may remain after the fracturing fluid flows out of the well bore. These proppant particulates may “prop” fractures 116 such that fluids may flow more freely through the fractures 116.

While not specifically illustrated herein, the disclosed methods and compositions may also directly or indirectly affect any transport or delivery equipment used to convey the compositions to the fracturing system 10 such as, for example, any transport vessels, conduits, pipelines, trucks, tubulars, and/or pipes used to fluidically move the compositions from one location to another, any pumps, compressors, or motors used to drive the compositions into motion, any valves or related joints used to regulate the pressure or flow rate of the compositions, and any sensors (i.e., pressure and temperature), gauges, and/or combinations thereof, and the like.

To facilitate a better understanding of the present disclosure, the following examples of certain aspects of some embodiments are given. In no way should the following examples be read to limit, or define, the entire scope of the disclosure or claims.

### EXAMPLES

### Example 1

A slurry of the present disclosure was prepared by first adding 20 ppg of WG-37™ (a xanthan gelling agent available from Halliburton Energy Services, Inc.) to 50 mL of water containing 0.5% w/w of Laponite® nanoparticles in a plastic beaker. The gel slurry was stirred with an overhead stirrer at a rate sufficient to form a shallow vortex. While stirring, 90 g of WAC-9™ silica flour (i.e., an equivalent concentration of 15 ppg) was slowly added and completely mixed into the gel slurry. Even at this concentration, the slurry was still pourable and pumpable. After allowing the slurry to sit without disturbance for 2 days, the silica flour had not significantly settled out of the slurry.

### Example 2

A second slurry of the present disclosure was prepared by first adding 20 ppg of WG-37™ to 50 mL of water in a plastic beaker. The gel was stirred with an overhead stirrer at a rate sufficient to form a shallow vortex. While stirring, 90 g of WAC-9™ silica flour (i.e., an equivalent concentration of 15 ppg) was slowly added and completely mixed into the gel. Even at this concentration, the slurry was still pourable and pumpable. After allowing the slurry to sit without disturbance for 2 days, the silica flour had not significantly settled out of the slurry.

### Example 3

A third slurry of the present disclosure was prepared by first adding 20 ppg of WG-37™ to 50 mL of water containing 3% w/v of sodium bromide (NaBr) salt in a plastic beaker. The gel was stirred with an overhead stirrer at a rate sufficient to form a shallow vortex. While stirring, 90 g of WAC-9™ silica flour (i.e., an equivalent concentration of 15 ppg) was slowly added and completely mixed into the gel. Even at this concentration, the slurry was still pourable and pumpable. After allowing the slurry to sit without disturbance for 2 days, the silica flour had not significantly settled out of the slurry.

### Example 4

A fourth slurry of the present disclosure was prepared by first adding 20 ppg of WG-37™ to 50 mL of water containing 3% w/v of sodium bromide (NaBr) salt in a plastic beaker. The gel was stirred with an overhead stirrer at a rate sufficient to form a shallow vortex. While stirring, 105 g of N-1000 Zeeospheres™ (i.e., an equivalent concentration of 17.5 ppg) was slowly added and completely mixed into the gel. Even at this concentration, the slurry was still pourable and pumpable.

An embodiment of the present disclosure is a method comprising: providing a fluid comprising an aqueous fluid and one or more gelling agents; mixing one or more small-sized solid materials into the fluid to form a slurry; storing the slurry for a period of storage time; mixing at least a portion of the slurry with a base fluid after the period of storage time to form a treatment fluid; and introducing the treatment fluid into a well bore penetrating at least a portion of a subterranean formation.

Another embodiment of the present disclosure is a method comprising: providing a slurry comprising an aqueous fluid, one or more gelling agents, and one or more small-sized solid materials; mixing at least a portion of the slurry with a base fluid to form a fracturing fluid; and introducing the fracturing fluid into a portion of a well bore penetrating at least a portion of a subterranean formation at or above a pressure sufficient to create or enhance one or more fractures in the portion of the subterranean formation.

Another embodiment of the present disclosure is a method comprising: providing an aqueous gel comprising an aqueous fluid and one or more gelling agents; mixing one or more small-sized solid materials into the aqueous gel to form a slurry; storing the slurry for a period of storage time; mixing at least a portion of the slurry with a base fluid after the period of storage time to form a fracturing fluid; introducing the fracturing fluid into a portion of a well bore penetrating at least a portion of a subterranean formation at or above a pressure sufficient to create or enhance one or more microfractures in the portion of the subterranean formation; and allowing one or more of the small-sized solid materials to enter an open space in one or more of the microfractures.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered or modified and all such variations are considered within the scope and spirit of the present disclosure. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an”, as used in the claims, are defined herein to mean one or more than one of the element that it introduces. If there is any conflict in the usages of a word or term in this specification and one or more patent or other documents that may be incorporated herein by reference, the definitions that are consistent with this specification should be adopted.

What is claimed is:

1. A method comprising:
providing a fluid comprising an aqueous fluid and one or more gelling agents;
mixing one or more small-sized solid materials into the fluid to form a slurry;
storing the slurry for a period of storage time;
mixing at least a portion of the slurry with a base fluid after the period of storage time to form a treatment fluid; and
introducing the treatment fluid into a well bore penetrating at least a portion of a subterranean formation.

2. The method of claim 1 further comprising mixing a plurality of nano-sized solids into the aqueous fluid, and wherein the small-sized solid materials mixed into the aqueous gel comprise micron-sized solids.

3. The method of claim 1 wherein the period of storage time is from about 2 days to about 3 weeks.

4. The method of claim 1 wherein the small-sized solid materials comprise a combination of micron-sized particulates and nano-sized particulates.

5. The method of claim 1 wherein the small-sized solid materials comprise a plurality of micron-sized particulates having particle sizes of from about 1 micron to about 250 microns.

6. The method of claim 1 wherein the small-sized solid materials comprise a plurality of nano-sized particulates having particle sizes of from about 10 nanometers to about 1000 nanometers.

7. The method of claim 1 wherein the small-sized solid materials comprise a plurality of micron-sized fibers.

8. The method of claim 1 wherein the small-sized solid materials comprise silica flour.

9. The method of claim 1 wherein the small-sized solid materials are present in the slurry in a concentration of about 1 pound per gallon to about 30 pounds per gallon by volume of the slurry.

10. (canceled)

11. (canceled)

12. A method comprising:
providing a slurry comprising an aqueous fluid, one or more gelling agents, and one or more small-sized solid materials;
mixing at least a portion of the slurry with a base fluid to form a fracturing fluid; and
introducing the fracturing fluid into a portion of a well bore penetrating at least a portion of a subterranean formation at or above a pressure sufficient to create or enhance one or more fractures in the portion of the subterranean formation.

13. The method of claim 12 further comprising storing the slurry for a period of time before mixing at least a portion of the slurry into the base fluid to form the fracturing fluid.

14. The method of claim 12 further comprising allowing one or more of the solid materials to enter an open space in one or more of the fractures in the portion of the subterranean formation.

15. The method of claim 12 wherein the step of mixing at least a portion of the slurry into a base fluid to form a fracturing fluid is performed at a well site where the well bore is located.

16. The method of claim 12 wherein the one or more fractures comprise one or more microfractures, and the method further comprises allowing one or more of the small-sized solid materials to enter an open space in one or more of the microfractures.

17. (canceled)

18. (canceled)

19. (canceled)

20. The method of claim 12 wherein the fracturing fluid is introduced into the well bore using one or more pumps.

21. The method of claim 12 wherein the small-sized solid materials comprise a plurality of micron-sized particulates having particle sizes of from about 1 micron to about 250 microns.

22. The method of claim 12 wherein the small-sized solid materials comprise a plurality of nano-sized particulates having particle sizes of from about 10 nanometers to about 1000 nanometers.

23. A method comprising:
providing a fluid comprising an aqueous fluid and one or more gelling agents;
mixing one or more small-sized solid materials into the fluid to form a slurry;
storing the slurry for a period of storage time;
mixing at least a portion of the slurry with a base fluid after the period of storage time to form a fracturing fluid;
introducing the fracturing fluid into a portion of a well bore penetrating at least a portion of a subterranean formation at or above a pressure sufficient to create or enhance one or more microfractures in the portion of the subterranean formation; and
allowing one or more of the small-sized solid materials to enter an open space in one or more of the microfractures.

24. (canceled)

25. The method of claim 23 wherein the small-sized solid materials comprise a plurality of micron-sized particulates having particle sizes of from about 1 micron to about 250 microns.

26. The method of claim 23 wherein the small-sized solid materials comprise a plurality of nano-sized particulates having particle sizes of from about 10 nanometers to about 1000 nanometers.
